(19) United States
(12) Patent Application Publication
(10) Pub. No.: US 2026/0151290 A1
(43) Pub. Date: Jun. 4, 2026

(54) AIR INFLATABLE MASSAGE CUSHION

(71) Applicant: Dongguan Jiashuan Industrial Co., Ltd., Dongguan (CN)

(72) Inventor: PEI-LIN TSAI, Dongguan (CN)

(21) Appl. No.: 19/459,183

(22) Filed: Jan. 26, 2026

Related U.S. Application Data
(63) Continuation-in-part of application No. 17/157,375, filed on Jan. 25, 2021, now Pat. No. 12,533,282.

(30) Foreign Application Priority Data
Oct. 13, 2020 (CN) 202011092989.5
Dec. 23, 2025 (CN) 202522736945.6

(51) Int. Cl. A61H 9/00

(52) U.S. Cl. CPC A61H 9/0078; A61H 2201/0146; A61H 2201/0149; A61H 2201/5048; A61H 2201/5056

(57) ABSTRACT

The present disclosure provides an air inflatable massage cushion including at least one body, each body including an inflation portion and an edge portion surrounding the inflation portion, the inflation portion includes a first inflating structure and a second inflating structure, and the first inflating structure is airtight sealed from the second inflating structure, the first inflating structure comprises a first air inflation unit having at least two first airbags, and the second inflating structure comprises a second air inflation unit having at least two second airbags, the at least two first airbags are airtight sealed from the at least two second airbags. In response to one of the first air inflation unit and the second air inflation unit is inflating, another one of the first air inflation unit and the second air inflation unit is deflating, the inflation portion dynamically changes height in a staggered manner.

### CROSS-REFERENCE TO RELATED APPLICATIONS

This application is continuation in part application of application Ser. No. 17/157375, filed on Jan. 25, 2021, which claims the benefit of priority to Chinese Patent Application Number 202011092989.5 filed on Oct. 13, 2020, and claims the benefit of priority to Chinese Patent Application Number 202522736945.6 filed on Dec. 23, 2025. The entire contents of the above-identified application are hereby incorporated by reference.

### TECHNICAL FIELD

The disclosure relates to an air inflatable massage cushion which is capable of inflating or deflating air alternately.

### BACKGROUND

In traditional airbag cushions, air nozzles are generally arranged in a concealed configuration to achieve a neatness appearance of the airbag cushions. This configuration requires an additional installation of dedicated air guide pipes, and often fails to maximize effective gas circulation, and may cause airflow obstruction during the buffering process and lead to uneven pressure distribution inside the airbags. Therefore, it is imperative to optimize the arrangement positions of the air holes, so as to improve the gas circulation performance and ensure the stability of the airbags in terms of buffering and pressure regulation.

### BRIEF DESCRIPTION OF DRAWINGS

Implementations of the present disclosure will now be described, by way of embodiment, with reference to the attached figures.

FIG. 1 is a schematic diagram of an overall structure of a massage cushion according to first embodiment of the present disclosure.

FIG. 2 is a bottom view of the massage cushion according to first embodiment of the present disclosure.

FIG. 3 is a top view of a massage cushion body of the massage cushion according to first embodiment of the present disclosure.

FIG. 4 is a bottom view of the massage cushion body of the massage cushion according to first embodiment of the present disclosure.

FIG. 5 is an assembly diagram of a control box of the massage cushion according to first embodiment of the present disclosure.

FIG. 6 is an exploded view of the control box shown in FIG. 5.

FIG. 7 is a bottom view of a massage cushion formed by connecting multiple massage cushion bodies according to second embodiment of the present disclosure.

FIG. 8 is an enlarged partial view of part A in FIG. 7.

FIG. 9 is a structural diagram of a second cushion layer among the multiple massage cushion bodies according to second embodiment of the present disclosure.

FIG. 10 is a structural diagram of a second cushion layer when the massage cushion is applied as a mattress according to third embodiment of the present disclosure.

FIG. 11 is a schematic diagram of the massage cushion applied as a sofa cushion according to fourth embodiment of the present disclosure.

FIG. 12 is a top view of the massage cushion body of the massage cushion according to fifth embodiment of the present disclosure.

FIG. 13 is a top view of the massage cushion body of the massage cushion according to sixth embodiment of the present disclosure.

FIG. 14 is a top view of the massage cushion body of the massage cushion according to seventh embodiment of the present disclosure.

FIG. 15 is a top view of the massage cushion body of the massage cushion according to eighth embodiment of the present disclosure.

FIG. 16 is a top view of the massage cushion body of the massage cushion according to ninth embodiment of the present disclosure.

FIG. 17 is a bottom view of the massage cushion body of the massage cushion according to tenth embodiment of the present disclosure.

FIG. 18 is a bottom view of the massage cushion body of the massage cushion according to eleventh embodiment of the present disclosure.

FIG. 19 is a bottom view of the massage cushion body of the massage cushion according to twelfth embodiment of the present disclosure.

FIG. 20 is a bottom view of the massage cushion body of the massage cushion according to thirteenth embodiment of the present disclosure.

FIG. 21 is a bottom view of the massage cushion body of the massage cushion according to fourteenth embodiment of the present disclosure.

FIG. 22 is a bottom view of the massage cushion body of the massage cushion according to fifteenth embodiment of the present disclosure.

### DETAILED DESCRIPTION

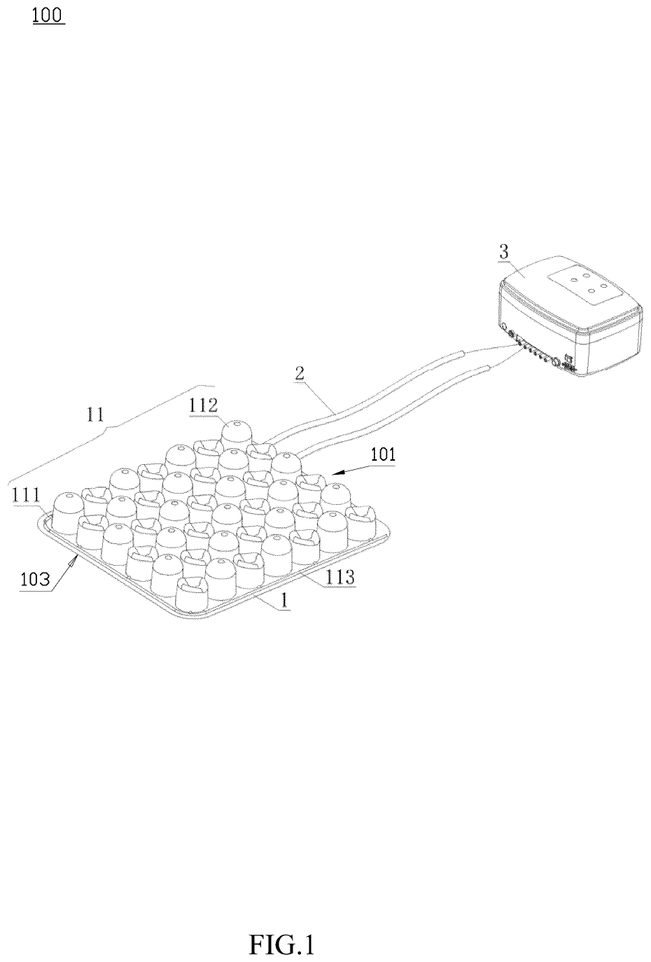

Referring to FIG. 1 to FIG. 6, a first embodiment of the present disclosure provides a massage cushion 100 having inflation and deflation functions. The massage cushion 100 includes at least one massage cushion body 1, at least two air tubes 2, and a control box 3. The at least one massage cushion body (sometimes abbreviated as body) 1 is connected to the control box 3 via the at least two air tubes 2. In this embodiment, the massage cushion 100 is exemplarily described as including one massage cushion body 1, two air tubes 2 and the control box 3.

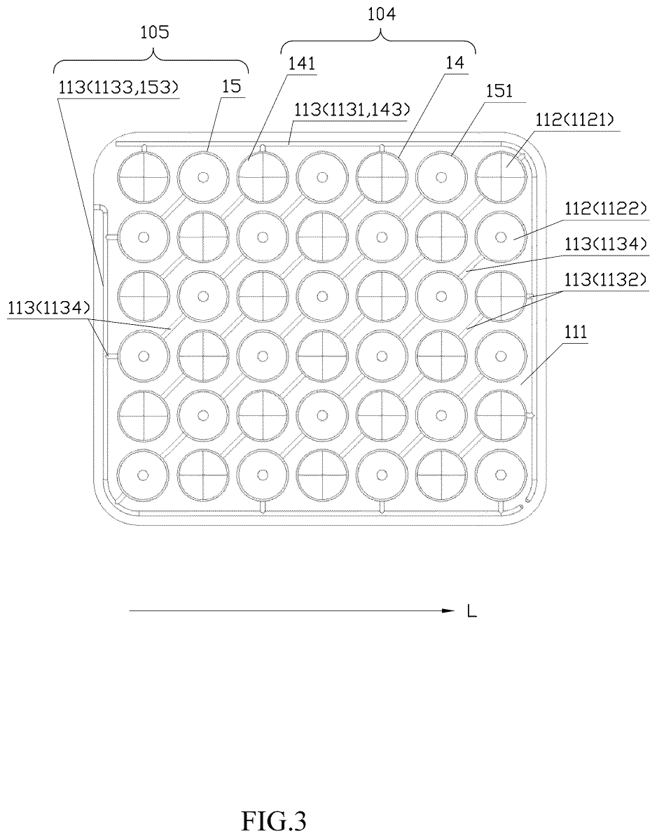

Referring to FIG. 1 and FIG. 3, each the massage cushion body 1 includes an inflation portion 101 and an edge portion 103 arranged surrounding the inflation portion 101, the inflation portion 101 includes a first inflating structure 104 and a second inflating structure 105, and the first inflating structure 104 is airtight sealed from the second inflating structure 105, the first inflating structure 104 includes a first air inflation unit 14 having at least two first airbags 1121 interconnected with each other, and the second inflating structure 105 includes a second air inflation unit 15 having at least two second airbags 1122 interconnected with each other, the at least two first airbags 1121 are airtight sealed from the at least two second airbags 1122, and the at least two first airbags 1121 and the at least two second airbags 1122 are arranged in a staggered manner. In addition, the first airbags 1121 and the second airbags 1122 are sometimes collectively referred to as airbag 112.

Each of the first air inflation unit 14 and the second air inflation unit 15 is configured to be connected to the control box 3 via a corresponding air tube 2, and in response to one of the first air inflation unit 14 and the second air inflation unit 15 is inflating, another one of the first air inflation unit 14 and the second air inflation unit 15 is deflating, thereby enabling the inflation portion 101 to dynamically change height in a staggered manner.

In addition, the first inflating structure 104 further includes a first air channel 1131 adjacent to the edge of one side of the massage cushion 100 and a plurality of first air guide channels 1132 located between two adjacent first airbags 1121 and between the first airbags 1121 and the first air channel 1131. In this embodiment, the first air channel 1131 functions as a first air passage 143, so that the first air inflation unit 14 is connected to the one of the two air tubes 2 via the first air passage 143, thereby inflating or deflating the at least two first airbags 1121 of the first air inflation unit 14.

The second inflating structure 105 further includes a second air channel 1133 adjacent to the edge of another side of the massage cushion 100 and a plurality of second air guide channels 1134 located between two adjacent second airbags 1122 and between the second airbags 1122 and the second air channels 1133. The second air channel 1133 functions as a second air passage 153, so that the second air inflation unit 15 is connected to the other one of the two air tube 2 via the second air passage 153, thereby inflating or deflating at least two second airbags 1122 of the second air inflation unit 15. In addition, the first air channel 1131, the first air guide channels 1132, the second air channel 1133 and the air guide channels 1134 are sometimes collectively referred to as air channel 113. In this embodiment, the at least two first airbags 1121, the at least two second airbags 1122, the first air channel 1131, the plurality of first air guide channels 1132, the second air channel 1133, and the plurality of second air guide channels 1134 are integrated structure.

In addition, each of at least part of the first air passage 143 and at least part of the second air passage 153 is a linear air channel. In this embodiment, a shape enclosed by the second air channel 1133 and the first air channel 1131 approximates an outline of the massage cushion 100. In this embodiment, the massage cushion 100 has a square structure, the first air channel 1131 is in an “L” shape and the second air channel 1133 is in an inverted “L” shape.

In addition, referring to FIG. 3, the first air inflation unit 14 includes a plurality of first airbag groups 141. Each of the plurality of first airbag groups 141 is in air communication with the corresponding air tube 2 via the first air channel 1131, and includes at least one first airbag 1121 connected in series. The second air inflation unit 15 includes a plurality of second airbag groups 151. Each of the plurality of second airbag groups 151 is in air communication with the corresponding air tube 2 via the second air channel 1133 and includes at least one second airbag 1122 connected in series. In this embodiment, the first airbags 1121 in each of the plurality of first airbag groups 141 and the second airbags 1122 in each of the plurality of second airbag groups 151 are arranged along a first direction X and arranged in a staggered manner and arranged at a 45-degree angle relative to an extending direction L of at least a portion of the first air channel 1131 or the second air channel 1133. When the massage cushion 100 is powered on and in operation, the first airbags 1121 of the first air inflation unit 14 and the second airbags 1122 of the second air inflation unit 15 alternately protrude and recess to achieve alternating movement, thereby fulfilling the functions of ventilation and massage.

In some embodiment, the massage cushion 100 includes at least one arrangement unit, a configuration of the at least one arrangement unit is a repeated layout. Each of the arrangement unit includes M groups of the first airbag groups 141 and N groups of the second airbag groups 151, M and N are each integers greater than or equal to 1. In this embodiment, both M and N are set to 1, meaning that the airbag groups are arranged alternately in a sequence of one first airbag group 141, one second airbag group 151, one first airbag group 141, one second airbag group 151, and so on.

In this embodiment, the at least one first airbag 1121 is arranged adjacent to the second airbag 1122 on at least two sides, which are selected from two sides of the first airbag 1121 in a second direction Y and two sides of the first airbag 1121 in a third direction Z perpendicular to the second direction Y, and the at least one second airbag 1122 is arranged adjacent to the first airbag 1121 on at least two sides, which are selected from two sides of the second airbag 1122 in the second direction Y and two sides of the second airbag 1122 in the third direction Z, the second direction Y is intersected with the first direction X, which is an first arrangement direction of the first airbags in each of the first airbag groups 141.

In other embodiments, M and N may be different. For example, the airbag groups are arranged alternately in a sequence of one first airbag group 141, two second airbag groups 151, two first airbag groups 141, one second airbag group 151, and so on.

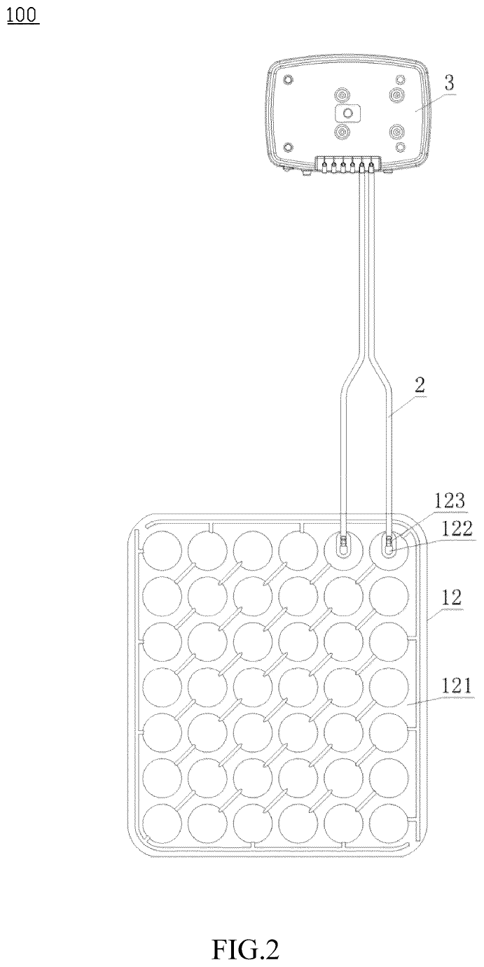

In addition, referring to FIG. 1 and FIG. 2, each of the at least one massage cushion body 1 includes a first cushion layer 11 and a second cushion layer 12 stacked with the first cushion layer 11. The first cushion layer 11 includes a first surface (top surface) 111, a plurality of airbags 112 and a plurality of air channels 113, which are arranged upwardly protruding from the first surface 111. That is, each of the plurality of airbags 112 and the plurality of air channels 113 is a hollow structure of protrusion of the first cushion layer 11 protruding outward away from the second cushion layer 12.

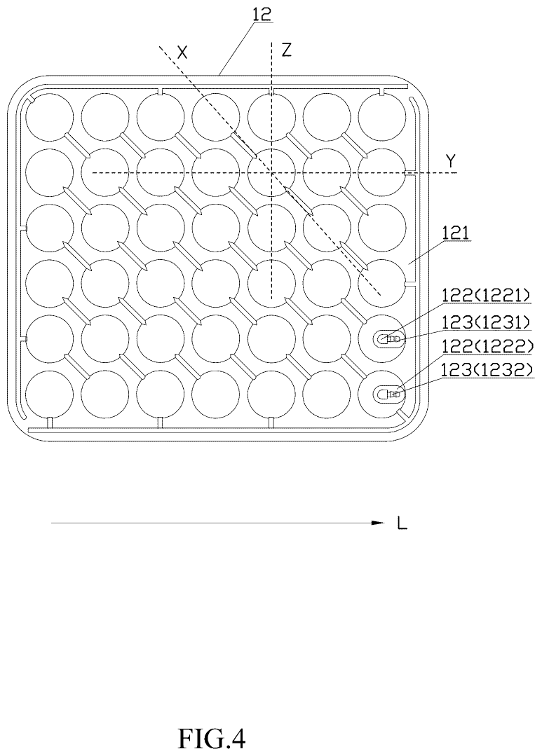

Referring to FIG. 4, the second cushion layer 12 includes a second surface 121 (bottom face) of the massage cushion body 1. In this embodiment, the first cushion layer 11 serves as the upper cushion layer of the massage cushion 100, and the second cushion layer 12 serves as the lower cushion layer of the massage cushion 100.

The two air orifices 122 includes a first air orifice 1221 and a second air orifices 1222, the first air orifice 1221 is positioned corresponding to the first inflating structure 104 in one of the first cushion layer 11 and the second cushion layer 12, and configured to be in air communication with a first airbag 1121 of the at least two first airbags 1121. And the second air orifice 1222 is positioned corresponding to the second inflating structure 105 in one of the first cushion layer 11 and the second cushion layer 12, and configured to be in air communication with a second airbag 1122 of the at least two airbags 1122. a first air nozzle arranged at the first air orifice; and a second air nozzle arranged at the second air orifice.

Two air nozzles 123 includes a first air nozzle 1231 and a second air nozzle 1232, the first air nozzle 1231 is arranged at the first air orifice 1221, the second air nozzle 1232 is arranged at the second air orifice 1122.

In this embodiment, referring to FIG. 4, the first air orifice 1221 is positioned in the second cushion layer 12 corresponding to a first airbag 1121 of the at least two first airbags 1121, and the second air orifices 1222 is positioned in the second cushion layer 12 corresponding to a second airbag 1122 of the at least two second airbags 1122. Both the first airbag 1121 corresponding to the first air orifice 1221 and the second airbag 1122 corresponding to the second air orifice 1222 are arranged proximate to an edge portion of the second cushion layer 12 and arranged adjacent to each other.

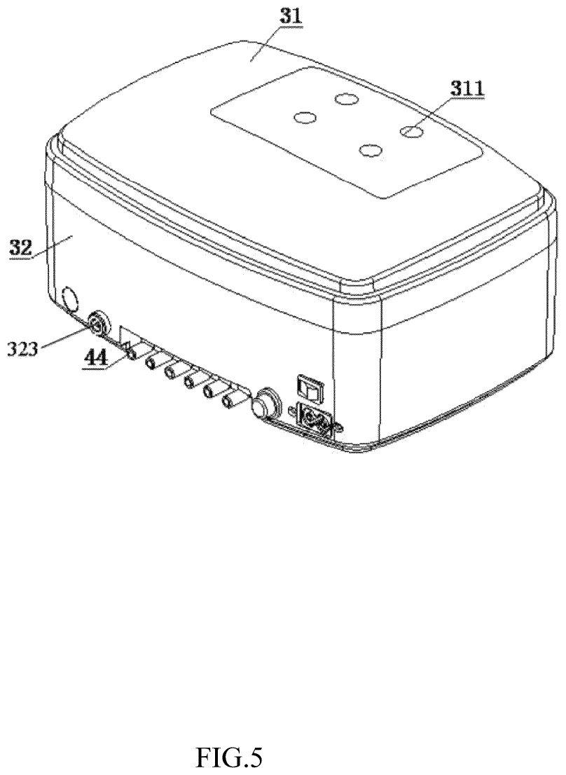

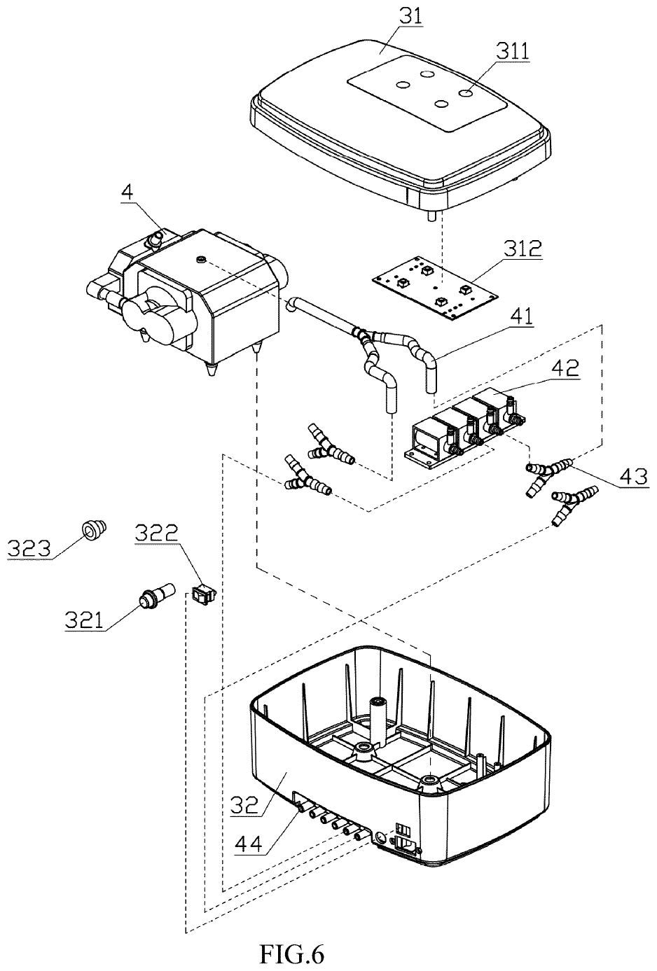

Further, referring to FIG. 5 and FIG. 6, an air pump 4 is accommodated in the control box 3, the control box 3 includes a first cap 31 and a second cap 32, both of which are made of plastic, a control panel 311 is disposed on the first cap 31 and electrically connected with a circuit board 312, and the circuit board 312 is connected to the air pump 4, the air pump 4 is connected to a valve element 42 via a plurality of connection tubes 41, and the valve element 42 is connected to a plurality of air outlets 44 via a plurality of Y-shaped tubes 43, the plurality of air outlets 44 are defined on the second cap 32 and in communication with the two air tubes 2.

In operation, air flows into the air pump 4 from the one of the first air inflation unit 14 and a second air inflation unit 15 via the corresponding one of the two air orifices 122, the corresponding one of the two air nozzles 123, and the corresponding one of the two air tubes 2. The air pump 4 then drives the airs to flow into the other one of the two air tube 2 through the plurality of connection tubes 41, the valve element 42, the plurality of Y-shaped tubes 43, and the plurality of air outlets 44. Subsequently, the air further flow into the other one of the first air inflation unit 14 and a second air inflation unit 15 via the other one of the two air tube 2.

Thereby, when the massage cushion 100 is powered on and activated, air is pumped into one of the first air inflation unit 14 and the second air inflation unit 15, while air is discharged from the other one of the first air inflation unit 14 and the second air inflation unit 15. This causes the first air inflation unit 14 and the second air inflation unit 15 to alternately bulge and retract. The valve element 42 supplies or draws air to or from the two air tubes 2 via the multiple y-shaped tubes 43.

The second cap 32 is provided with a fuse 321, a switch 322 and a power socket 323, with the power socket 323 and the switch 322 both connected to the air pump 4. The circuit board 312 drives four relays via their respective drive circuits, which correspond to three inflation levels and one deflation level. Specifically, the three inflation levels are differentiated by three distinct inflation durations, namely 1 minute, 3 minutes and 5 minutes. In addition, the time key, start key, massage level key and frequency key disposed on the circuit board are connected to a plurality of power indicators, which are configured to display the working time, working state and pumping frequency of the air pump 4, as well as the air exchange volume between the two inflation units.

The control circuit of the circuit board 312 is connected to a 220V AC power supply via a power supply module, such that the 220V AC power supply supplies power to the circuit board, and the plurality of power indicators display the working state of the power supply module. The power supply module is connected to a remote control receiver module, which is equipped with a receiving antenna configured to receive control signals from a remote control and transmit the signals to the control circuit of the circuit board. The circuit board then controls the operation of the air pump 4 based on the received control signals.

The remote control is provided with a transmitting module configured to control the power supply of the power supply module, receive control instructions input via the control keys of the remote control, and transmit the control instructions to the receiving antenna of the remote control receiver module through a transmitting antenna.

Upon power activation, the control box 3 inflates or deflates the inflatable massage cushion. In an alternative embodiment, the control box 3 may be replaced with an electric air pump. The power supply may be 200V mains electricity converted to voltages of 22V, 24V, 5V or 12V. Alternatively, a charger or a rechargeable battery may be used as the power supply.

In other embodiments, users can remotely control the massage cushion 100 through a mobile application (APP) (not shown). Specifically, the mobile application is installed on a mobile phone, and function buttons corresponding to the control box 3 are provided on an interface of the application, such as start/pause, gear selection, time setting, frequency adjustment, etc. When users operate the function buttons in the mobile application, a built-in wireless transmission module (such as Bluetooth or Wi-Fi module) of the mobile phone encodes the command information and sends to the massage cushion 100. The power supply module of the control box 3 is connected to a corresponding wireless receiving module, which receives the mobile phone command and transmits the mobile phone command to the main control circuit. The main control circuit controls the air pump 4 to perform actions such as inflation, deflation, and gear switching according to the mobile phone command. At the same time, the working status of the massage cushion (such as working time, gear, frequency) is fed back to the mobile phone application through the wireless module and displayed in real-time on the interface, thereby realizing two-way interaction.

In another embodiment, the users can also control the massage cushion 100 through voice commands. Specifically, a microphone, an audio processing unit, and a voice recognition module are additionally provided inside the control box 3. The microphone real-time captures the users'voice commands, such as “start massage”, “switch to medium gear”, “inflate for 3 minutes”, “deflate”, etc. The audio processing unit first performs noise reduction and amplification processing on the collected sound signals, and then the voice recognition module parses the semantic meaning of the commands, converts them into electrical signals recognizable by the main control circuit, and transmits them to the main control circuit. After receiving the signals, the main control circuit drives the corresponding relays and the air pump 4 to execute the commands, realizing corresponding functions such as inflation/deflation and gear switching. At the same time, the power indicator synchronously feeds back the working status corresponding to the current voice command, facilitating the user to confirm the execution of the command.

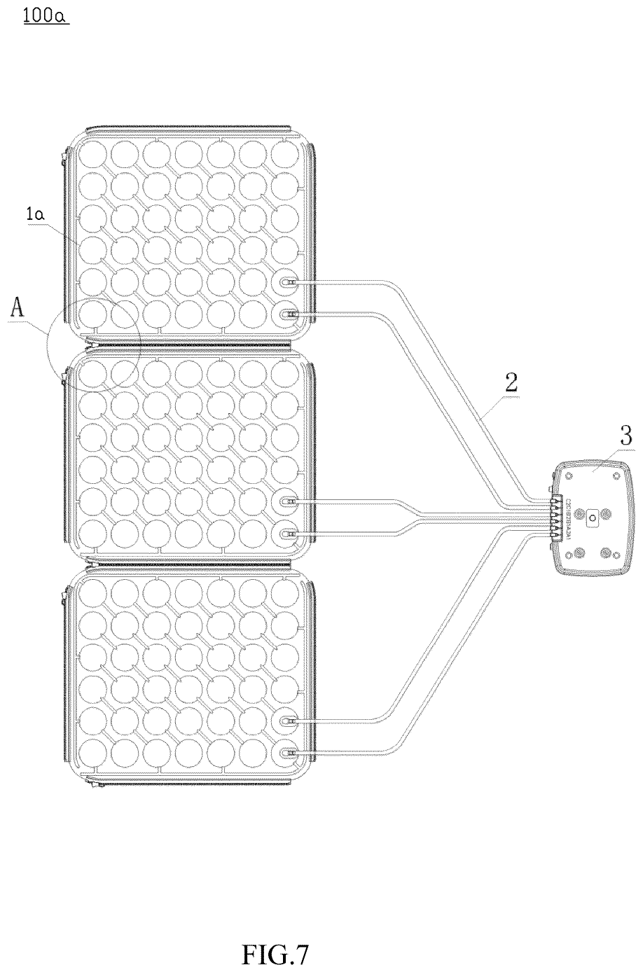

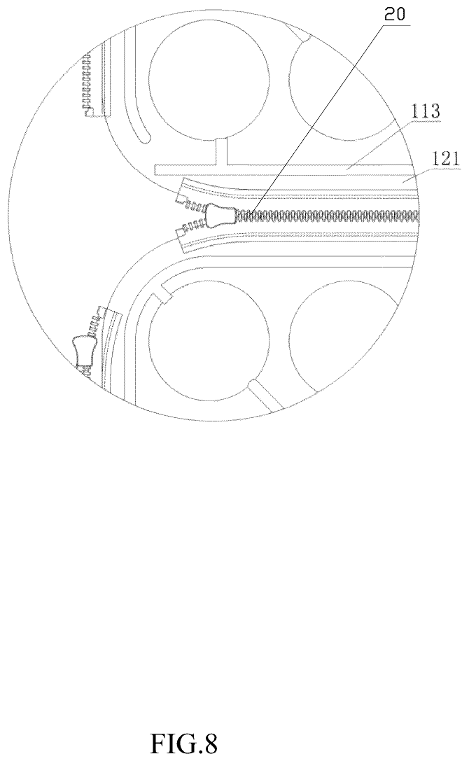

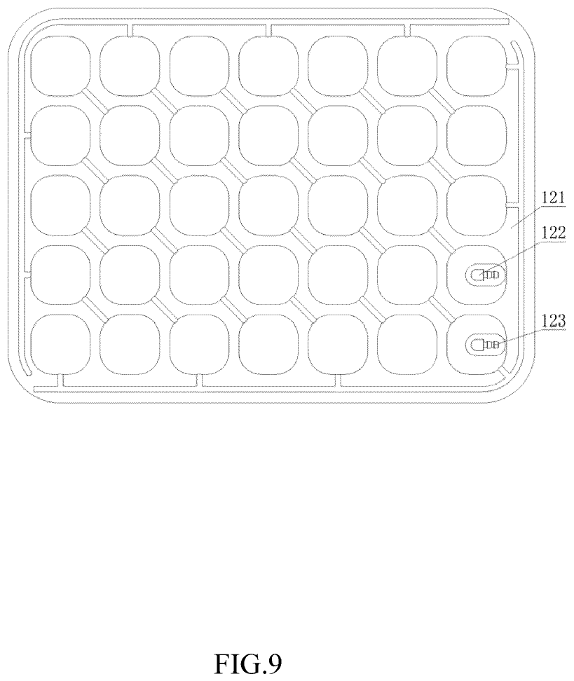

Referring to FIG. 7 to FIG. 9, the massage cushion 100a provided by a second embodiment includes at least two air massage cushion body 1a connected to each other via at least one zipper 20.

In this embodiment, the massage cushion 100a includes three air massage cushion body 1a having the same composition as the air massage cushion body 1 described in first embodiment, the control box 3 is connected to a plurality of air tubes 2, and each air massage cushion body 1a is connected to the control box 3 via two air tubes 2. Thereby, air is inflated into or deflated from the two inflation units of each respective massage cushion body 1a through the two air tubes 2.

A respective zipper 20 is sewn on a peripheral side of the first surface 121 (i.e. an outer wall of the respective air conduit 113) to connect any two massage cushion body 1a. In another embodiment, a plurality of air massage cushion bodies 1a are connected by at least one hook-and-loop fastener (not shown) or at least one button (not shown).

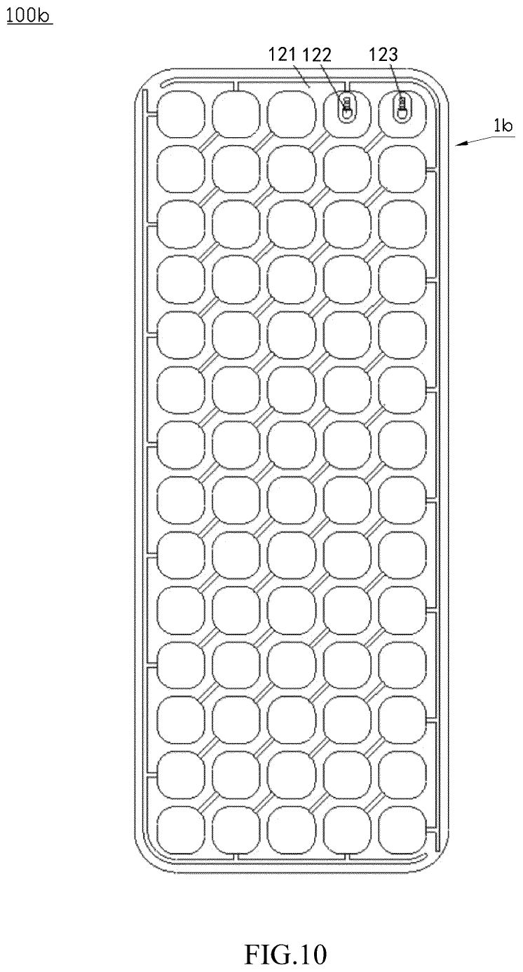

Referring to FIG. 10, the massage cushion 100b provided by a third embodiment includes massage cushion body 1b adapted for a bed mattress. Referring to FIG. 10, the massage cushion body 1b is formed in an elongated shape to suit the mattress. Alternatively, the massage cushion body 1b is formed in a square shape to suit the sofa cushion or to be disposed on the wheelchair.

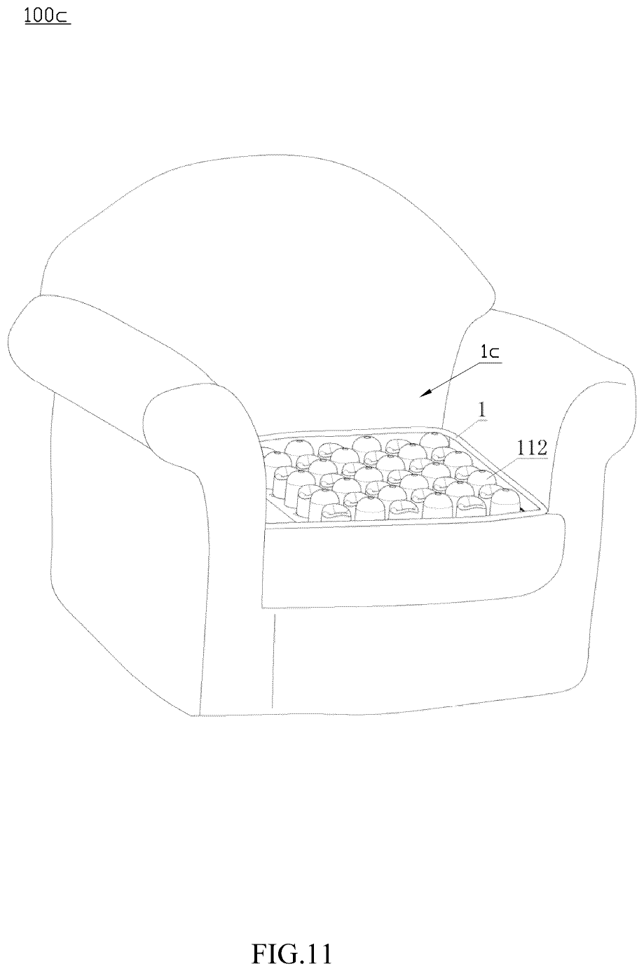

Referring to FIG. 11, the massage cushion 100c provided by a fourth embodiment comprises a massage cushion body 1c adapted for a sofa cushion or configured to be disposed on a wheelchair. Only the massage cushion body 1c is shown in FIG. 11, with the plurality of air tubes 2 and the control box 3 are not shown in FIG. 11.

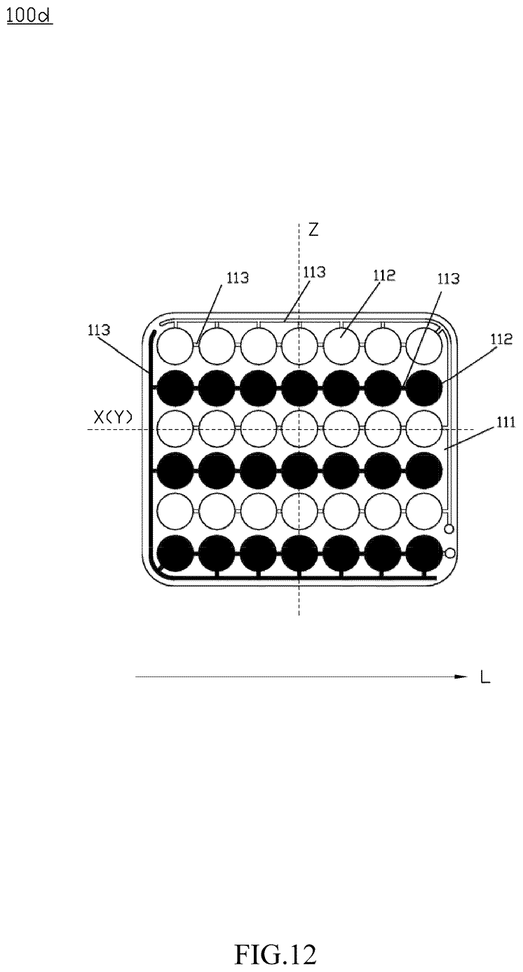

Referring to FIG. 12, a massage cushion 100d according to a fifth embodiment is different from the massage cushion 100 according to the first embodiment in an arrangement of the first air inflation unit 14 and the second air inflation unit 15.

In this embodiment, the plurality of first airbag group 141 of the first air inflation unit 14 and the plurality of second airbag group 151 of the second air inflation unit 15 are arranged horizontally and alternately. That is, the first airbags 1121 in each of the plurality of first airbag groups 141 and the second airbags 1122 in each of the plurality of second airbag groups 151 are arranged parallel to the extending direction L of a portion of the first air channel 1131 or the second air channel 1133. In addition, in this embodiment, the at least one first airbag 1121 is arranged adjacent to the second airbag 1122 on at least two sides, which are selected from two sides in a second direction Y and two sides in a third direction Z perpendicular to the second direction Y, and the at least one second airbag 1122 is arranged adjacent to the first airbag 1121 on at least two sides, which are selected from two sides in the second direction Y and two sides in the third direction Z, the second direction Y is arranged parallel to the first direction X.

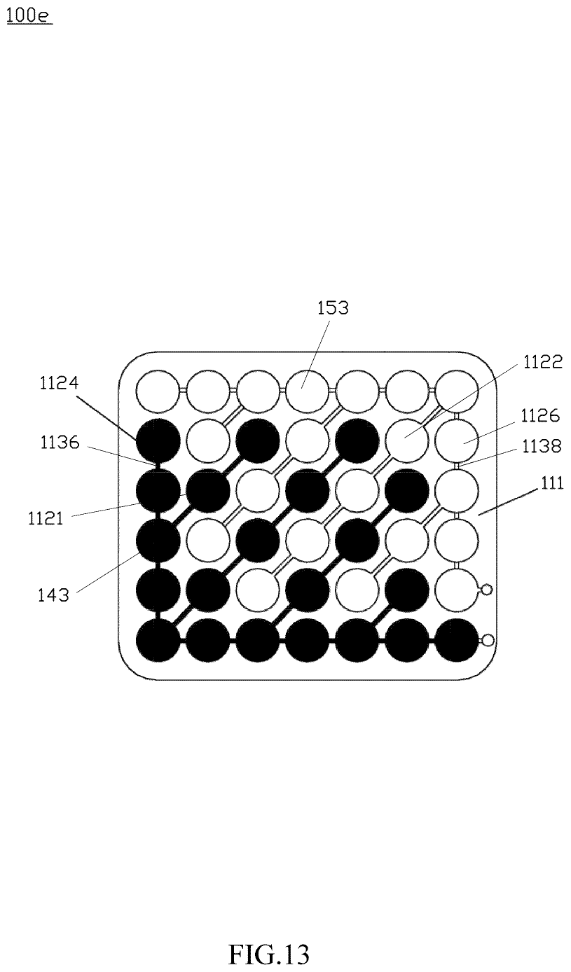

Referring to FIG. 13, a massage cushion 100e according to a sixth embodiment is different from the massage cushion 100 according to the first embodiment in the composition of the first air passage 143 and the second air passage 153.

In this embodiment, the first air passage 143 includes a plurality of first sub-airbags 1124 arranged closest to the edge of the massage cushion 100 and a plurality of first sub-air channels 1136, each of the plurality of first sub-air channels 1136 is correspondingly connected to two adjacent first sub-airbags 1124 of the plurality of first sub-airbags 1124. The second air passage 153 comprises a plurality of interconnected second sub-airbags 1126 arranged closest to the edge of the massage cushion 100 and a plurality of second sub-air channels 1138, each of the plurality of second sub-air channels 1138 is correspondingly connected to two adjacent second sub-airbags 1126 of the plurality of second sub-airbags 1126, the plurality of first sub-airbags 1124 is interconnected, and the plurality of second sub-airbags 1126 is interconnected.

In this embodiment, airbags are also provided on the first air passage 143 and the second air passage 153, which can not only optimize the structural layout of the massage cushion but also achieve differentiated massage effects and improve the user experience.

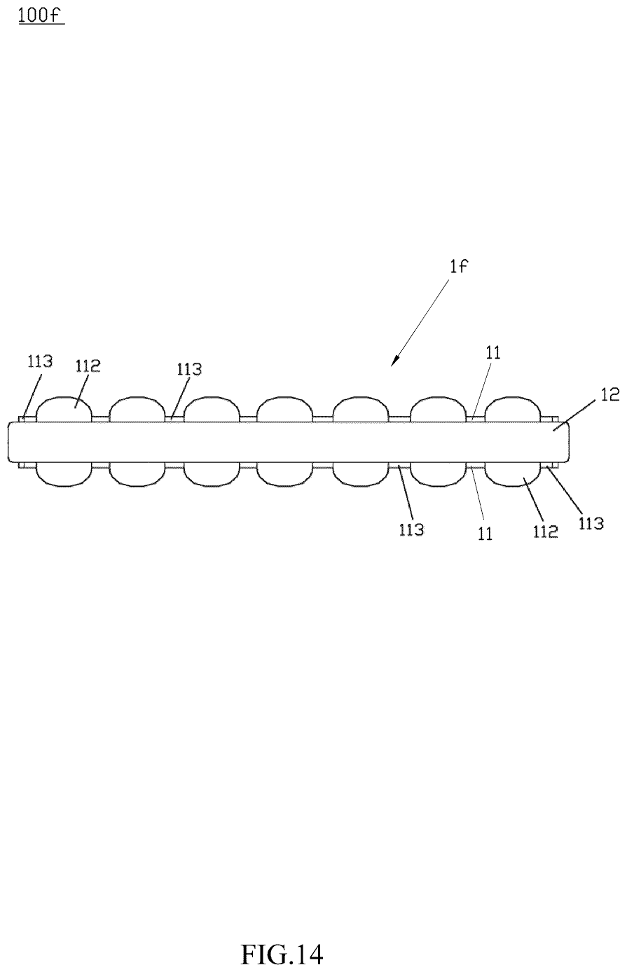

Referring to FIG. 14, the difference between an massage cushion 100f according to a seventh embodiment and the massage cushion 100 according to the first embodiment is that the massage cushion 100f is applicable for a mattress, the massage cushion body 1f includes two first cushion layers 11 at two opposite surfaces of the massage cushion body 1f, respectively, the second cushion layer 12 is between the two first cushion layers 11, each of the two first cushion layers 11 protrudes away from the second cushion layer 12 to form the first inflating structure 104 and the second inflating structure 105, respectively. In this embodiment, by arranging two first cushion layers 11, not only can the thickness of the massage cushion 100f be increased, but also the three-dimensional effect of height staggering can be made more pronounced.

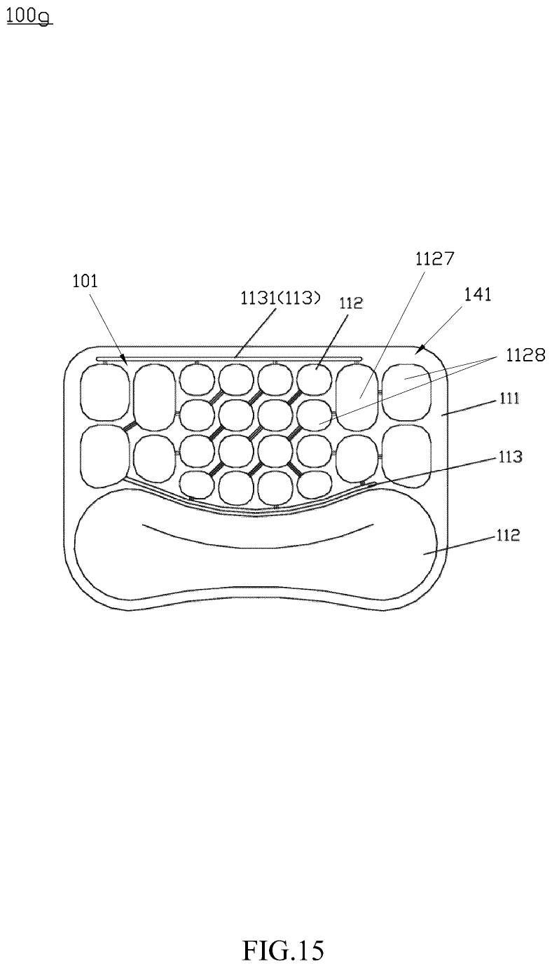

Referring to FIG. 15, the difference between a massage cushion 100g according to a seventh embodiment and the massage cushion 100 according to a first embodiment is that a plurality of airbags with different sizes are arranged in the massage cushion 100g, and the massage cushion 100g is configured as a pillow cushion.

In this embodiment, the size of the airbags 112 adjacent to the peripheral side of massage cushion body 1 is larger than that of the other airbags 112 arranged at the middle portion of the massage cushion body 1. Among the plurality of airbags 112, one airbag is configured in an elongated shape to support the user's neck.

In addition, the inflation portion 101 comprises a plurality of first airbag groups 141 in air communication with the first air channel 1131 and at least one second airbag group 151 not in air communication with the plurality of first airbag groups 141, at least one of the plurality of first airbag groups 141 comprises a primary airbag 1127 of the at least two first airbags 1121 connected to the first air channel 1131, and at least one secondary airbag 1128 of the at least two first airbags 1121 connected to the primary airbag 1127.

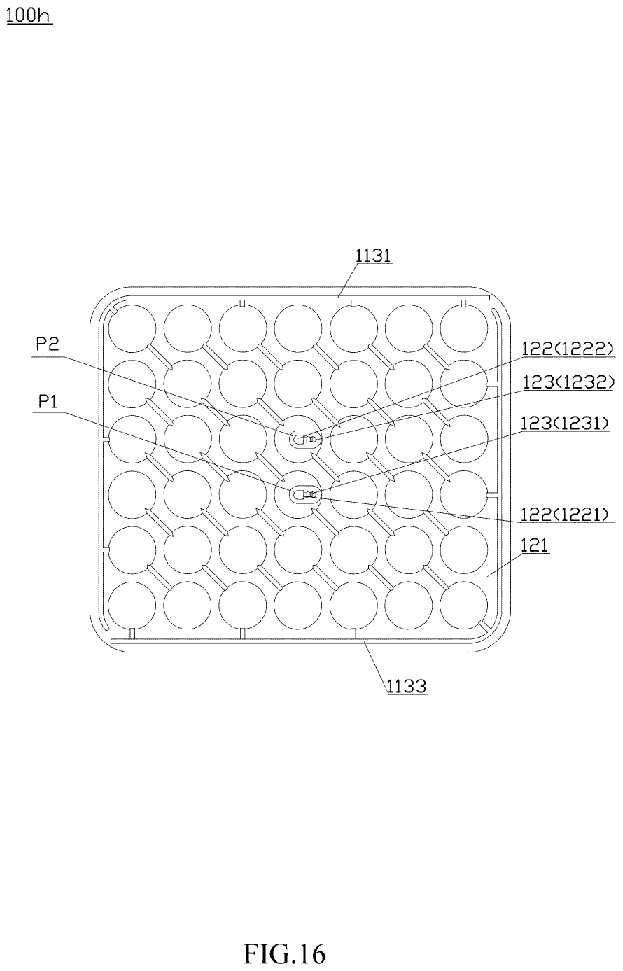

Referring to FIG. 16, The difference between of an air inflatable massage cushion 100h according to a ninth embodiment and the air inflatable massage cushion 100 according to the first embodiment is that the first air orifice 1121 is defined at a first position P1 on the second cushion layer 12 corresponding to a first airbag 1121 disposed in the central area of the first cushion layer 11, and the second air orifice 1121 is defined at a second position P2 on the second cushion layer 12 corresponding to a second airbag 1122 disposed in the central area of the first cushion layer 11. The first airbag 1121 provided with the first air orifice 1221 and the second airbag 1122 provided with the second air orifice 1222 are arranged adjacent to each other.

In other embodiments, the first airbag 1121 provided with the first air orifice 1221 and the second airbag 1122 provided with the second air orifice 1222 may not be arranged adjacent to each other, which is not limited herein.

In addition, the first airbag 1121 or the second airbag 1122 disposed in the central area refers to the first airbag 1121 not closest to the first air passage 143 of the massage cushion 100 and the second airbag 1122 not closest to the second air passage 153, respectively.

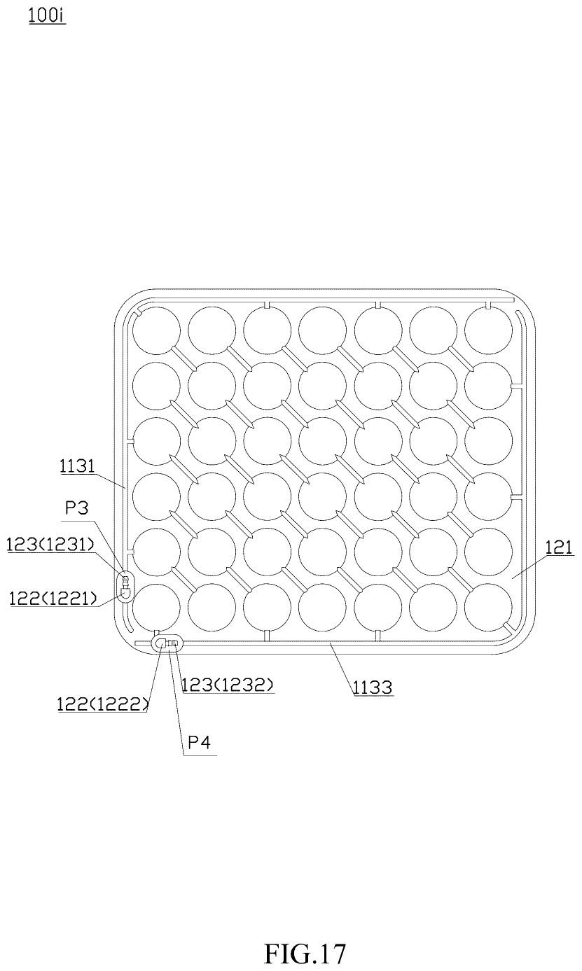

Referring to FIG. 17, the difference between an air inflatable massage cushion 100i according to a tenth embodiment and the air inflatable massage cushion 100 according to the first embodiment is that the first air orifice 1221 is defined at a position P3 on the second cushion layer 12 corresponding to the first air channel 1131 of the first air inflation unit 14, and the second air orifice 1122 is defined at a position P4 on the second cushion layer 12 corresponding to the second air channel 1133 of the second air inflation unit 15.

In this embodiment, the first air orifice 1221 and the second air orifice 1222 are arranged adjacent to each other, but in other embodiments, the first air orifice 1221 and the second air orifice 1222 may be arranged separately.

In this embodiment, although both the first air orifice 1221 and the second air orifice 1222 are defined on the second cushion layer 12, in other embodiments, they may be respectively defined on the first cushion layer 11 at the position corresponding to the first air channel 1131 of the first air inflation unit 14 and the position corresponding to the second air channel 1133 of the second air inflation unit 15, which is not limited herein.

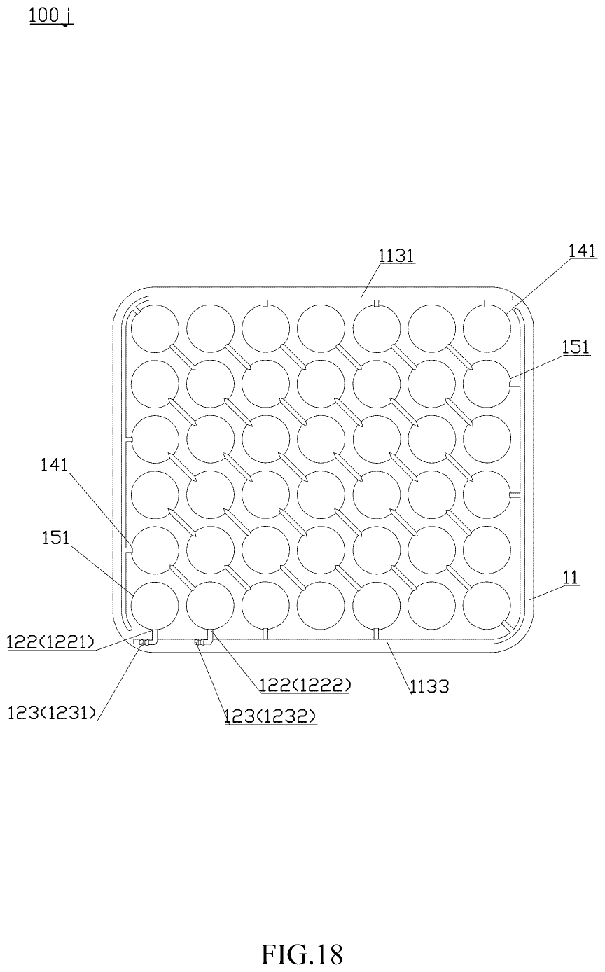

Referring to FIG. 18, the difference between an air inflatable massage cushion 100j according to a eleventh embodiment and the air inflatable massage cushion 100 according to the first embodiment is that the first air orifice 1221 is at a side wall of a first airbag 1121 of the at least two first airbags 1121 on the first cushion layer 11, one end of the first air nozzle 1231 is in the first air orifice 1221, and another end of the first air nozzle 1231 extends out of the first airbag 1121 to an external environment. The second air orifice 1222 is at a side wall of a second airbag 1122 of the at least two second airbags 1122 on the second cushion layer 12, and one end of the second air nozzle 1232 is in the second air orifice 1222, and another end of the second air nozzle 1232 extends out of the second airbag 1122 to the external environment.

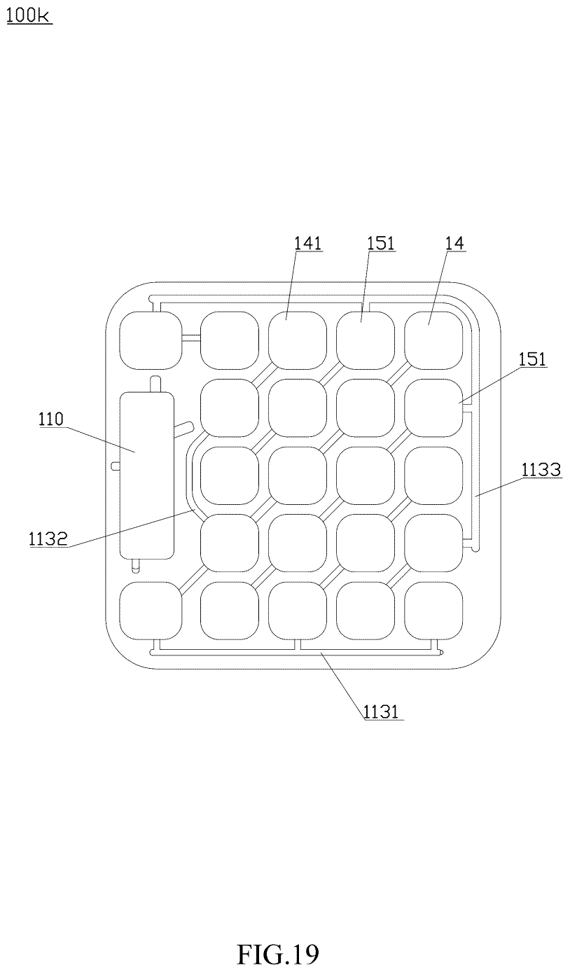

Referring to FIG. 19, the difference between an air inflatable massage cushion 100k according to a twelfth embodiment and the air inflatable massage cushion 100 according to the first embodiment is that the massage cushion 100 is further provided with a controller 110. The first air channel 1131 serving as the first air passage 143 is in a straight line shape, and the second air channel 1133 serving as the second air passage 153 is in an inverted L shape. One of the first airbag groups 141 is connected to the adjacent first airbag group 141 through the corresponding first guide channel 1132.

In this embodiment, although the first airbag group 141 is connected to the adjacent first airbag group 141 through the corresponding first guide channel 1132, in other embodiments, the second airbag group 151 may also be connected to the adjacent second airbag group 151 through the corresponding second guide channel 1134, which is not limited herein.

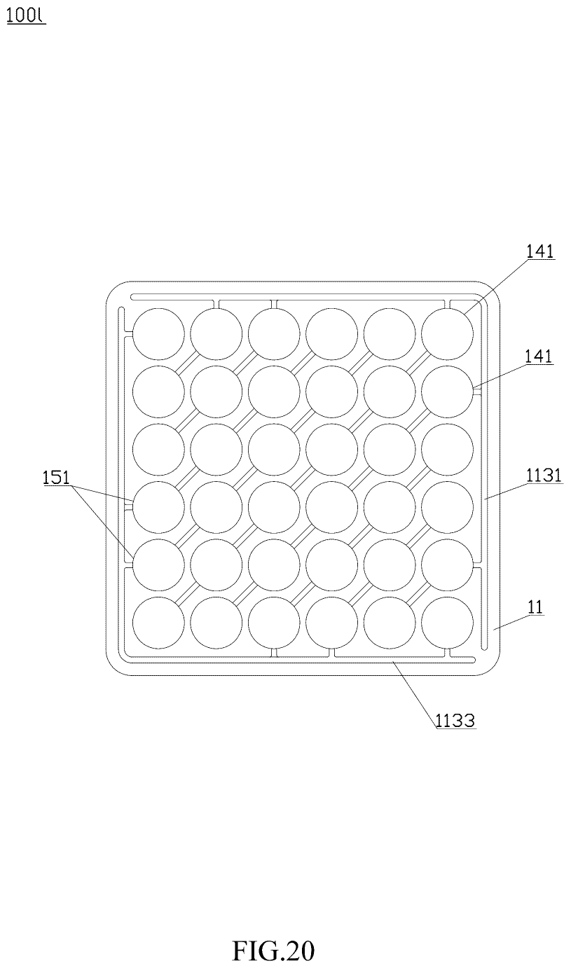

Referring to FIG. 20, an air inflatable massage cushion 100l according to a thirteenth embodiment and the air inflatable massage cushion 100 according to the first embodiment is that two first airbag groups 141 and two second airbag groups 151 form an arrangement unit and are repeatedly arranged. Other configurations are the same as those of the first embodiment, which are not limited herein.

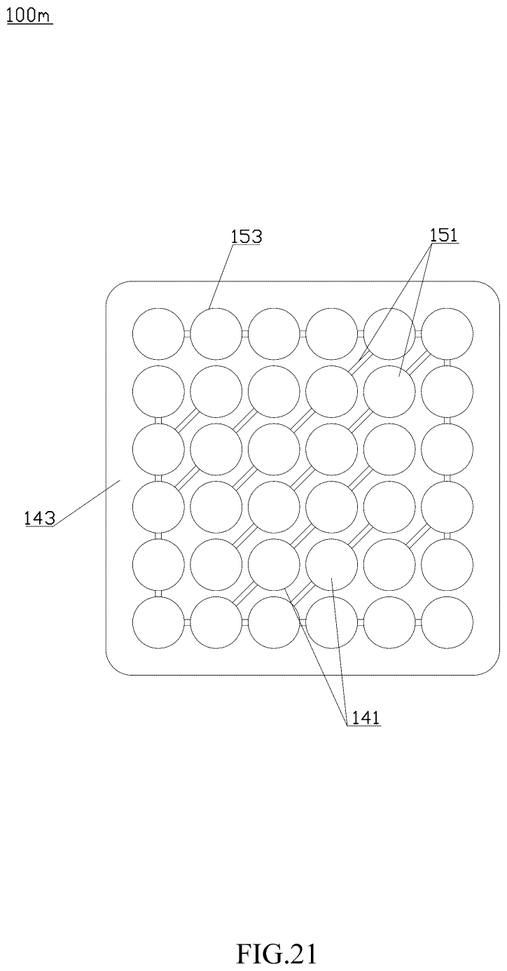

Referring to FIG. 21, an air inflatable massage cushion 100m according to a fourteenth embodiment and the air inflatable massage cushion 100e according to the sixth embodiment is that at least one first airbag group 141 and two second airbag groups 151 form an arrangement unit and are repeatedly arranged. Other configurations are the same as those of the sixth embodiment, which are not limited herein.

Therefore, the number of first airbag groups 141 and second airbag groups 151 may be equal or unequal, that is, they can be adjusted accordingly according to requirements, which is not limited herein.

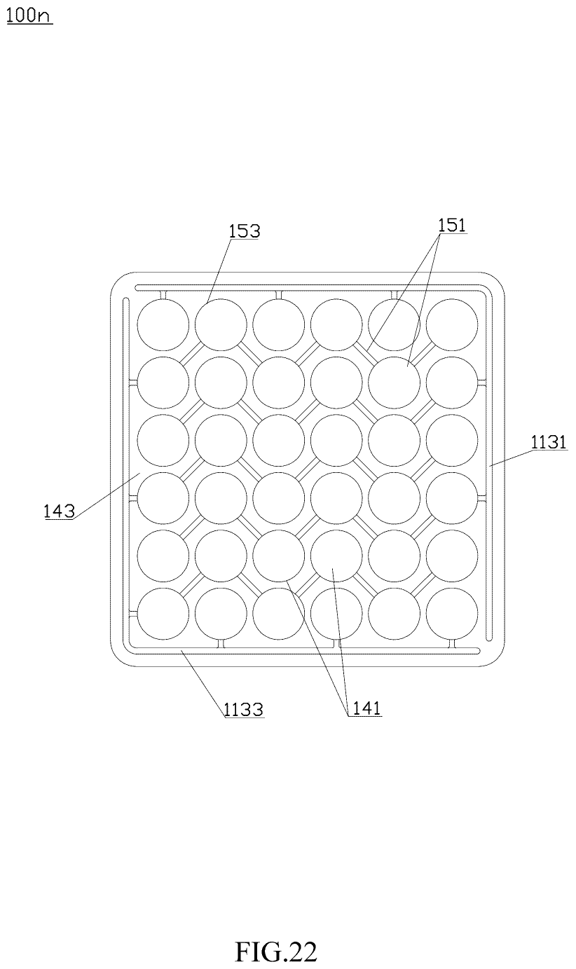

Referring to FIG. 22, an air inflatable massage cushion 100n according to a fifteenth embodiment and the air inflatable massage cushion 100e according to the sixth embodiment is that at least one first airbag group 141 and at least one second airbag group 151 are arranged in a non-linear manner. In this embodiment, both the at least one first airbag group 141 and the at least one second airbag group 151 are arranged in a wave-like manner.

In this embodiment, the first air passage 143 and the second air passage 153 can also be arranged in the same way as the first air passage 143 and the second air passage 153 in the sixth embodiment, which is not limited herein.

The inflatable massage cushion 100˜100n may be configured into any one of the following shapes: square, triangle, regular polygon, heart, star, and animal shape.

Preferably, the plurality of airbags 112 are adjustable in terms of shape, size, height and position, so as to meet diverse usage requirements. The inflatable massage cushion 100˜100n can be easily operated in a remote control manner.

The inflatable massage cushion 100˜100n is applicable to seat cushions, wheelchair cushions, sofa cushions, pillow cushions, and waist cushions.

Compared with the prior art, the positions of the air orifices of the massage cushion 100 of the present disclosure are flexible. The first air orifice 1221 is defined on the first cushion layer 11, or at the position of the second cushion layer 12 corresponding to the first air channel, or at the position of the second cushion layer 12 corresponding to a first airbag 1121 located in the central part, or on the side wall of a first airbag 1121. The second air orifice 1222 is defined on the first cushion layer 11, or at the position of the second cushion layer 12 corresponding to the second air channel, or at the position of the second cushion layer 12 corresponding to a second airbag 1122 located in the central part, or on the side wall of a second airbag 1122. This can better improve the smoothness of gas circulation. Moreover, the first air inflation unit 14 and the second air inflation unit 15 each have the air orifice and the air nozzle, and can be independently inflated and deflated.

What is claimed is:

1. An air inflatable massage cushion configured to be connect with a control box via a plurality of air tubes, the air inflatable massage cushion comprising:
at least one body comprising an inflation portion and an edge portion surrounding the inflation portion,
wherein the inflation portion comprises a first inflating structure and a second inflating structure, and the first inflating structure is airtight sealed from the second inflating structure, the first inflating structure comprises a first air inflation unit having at least two first airbags interconnected with each other, and the second inflating structure comprises a second air inflation unit having at least two second airbags interconnected with each other, the at least two first airbags are airtight sealed from the at least two second airbags, and the at least two first airbags and the at least two second airbags are arranged in a staggered manner,
each of the first air inflation unit and the second air inflation unit is configured to be connected to the control box via a corresponding air tube of the plurality of air tubes, and in response to one of the first air inflation unit and the second air inflation unit is inflating, another one of the first air inflation unit and the second air inflation unit is deflating, the inflation portion dynamically changes height in a staggered manner,
each body of the at least one body further comprises:
at least one first cushion layer and a second cushion layer stacked with the first cushion layer, wherein each of the first air inflation unit and the second air inflation unit is a hollow structure of protrusion of the first cushion layer protruding away from the second cushion layer;
a first air orifice positioned corresponding to the first inflating structure in one of the first cushion layer and the second cushion layer, and configured to be in air communication with a first airbag of the at least two first airbags;
a second air orifice positioned corresponding to the second inflating structure in one of the first cushion layer and the second cushion layer, and configured to be in air communication with a second airbag of the at least two airbags;
a first air nozzle arranged at the first air orifice; and a second air nozzle arranged at the second air orifice.

2. The air inflatable massage cushion according to claim 1, wherein the first inflating structure further comprises a first air passage extending along one side of the inflation portion, the at least two first airbags are in air communication with the corresponding air tube via the first air passage,
the second inflating structure further comprises a second air passage extending along another side of the inflation portion, the at least two second airbags are in air communication with the corresponding air tube via the second air passage.

3. The air inflatable massage cushion according to claim 2, wherein the first air inflation unit comprises a plurality of first airbag groups arranged in parallel, each of the plurality of first airbag groups comprises at least one first airbag connected in series,
the second inflating structure comprises a plurality of second airbag groups arranged in parallel, each of the plurality of second airbag groups comprises at least one second airbag connected in series,
the plurality of first airbag groups and the plurality of second airbag groups are alternately arranged, the first airbags of the plurality of first airbag groups are in air communication with the corresponding air tube via the first air passage, and the second airbags of the plurality of second airbag groups are in air communication with the corresponding air tube via the second air passage.

4. The air inflatable massage cushion according to claim 3, wherein
the at least one body further comprises at least one arrangement unit, a configuration of the at least one arrangement unit is a repeated layout, each of the arrangement unit includes M groups of the first airbag groups and N groups of the second airbag groups, M and N are each integers greater than or equal to 1.

5. The air inflatable massage cushion according to claim 3, wherein
the first airbags in each of the plurality of first airbag groups is arranged along a first direction and the second airbags in each of the plurality of second airbag groups is arranged along the first direction, the first direction is parallel to an extending direction of at least a portion of the first air passage or is parallel to an extending direction of at least a portion of the second air passage, or is oblique relative to the extending direction.

6. The air inflatable massage cushion according to claim 3, wherein at least one of the plurality of first airbag groups and at least one of the plurality of second airbag groups are arranged in a non-linear manner.

7. The air inflatable massage cushion according to claim 3, wherein
the at least one first airbag is arranged adjacent to the second airbag on at least two sides, which are selected from two sides of the first airbags in a second direction and two sides of the first airbags in a third direction perpendicular to the second direction, and the at least one second airbag is arranged adjacent to the first airbag on at least two sides, which are selected from two sides of the second airbag in the second direction and two sides of the second airbag in the third direction, the second direction is arranged parallel to an first arrangement direction of the first airbags in each of the first airbag groups or intersected with the first arrangement direction.

8. The air inflatable massage cushion according to claim 2, wherein the inflation portion comprises a plurality of first airbag groups in air communication with the first air passage and at least one second airbag group not in air communication with the plurality of first airbag groups, at least one of the plurality of first airbag groups comprises a primary airbag of the at least two first airbags connected to the first air passage, and at least one secondary airbag of the at least two first airbags connected to the primary airbag.

9. The air inflatable massage cushion according to claim 2, wherein the first inflating structure further comprises a plurality of first air guide channels, and each of the plurality of first air guide is = between two adjacent first airbags of the at least two first airbags or between the first airbag of the at least two first airbags and the first air passage;
the second inflating structure further comprises a plurality of second air guide channels, and each of the plurality of second air guide is between two adjacent second airbags of the at least two second airbags or between the second airbag of the at least two second airbags and the second air passage.

10. The air inflatable massage cushion according to claim 9, wherein the first air orifice is positioned in the second cushion layer corresponding to one first airbag of the at least two first airbags, in the first air passage or in one first air guide channel of the plurality of first air guide channels; the second air orifice is positioned in the second cushion layer corresponding to one second airbag of the at least two second airbags, in the second air passage or in one second air guide channel of the plurality of second air guide channels.

11. The air inflatable massage cushion according to claim 1, wherein the first air orifice is positioned in the second cushion layer corresponding to a first airbag of the at least two first airbags, and the second air orifice positioned in the second cushion layer corresponding to a second airbag of the at least two second airbags, the first airbag corresponding to the first air orifice is adjacent to the second airbag corresponding to the second air orifice.

12. The air inflatable massage cushion according to claim 11, wherein the first airbag corresponding to the first air orifice and the second airbag corresponding to the second air orifice are proximate to an edge portion or at a central area of the second cushion layer.

13. The air inflatable massage cushion according to claim 1, wherein the first air orifice is at a side wall of one first airbag of the at least two first airbags on the first cushion layer, one end of the first air nozzle is in the first air orifice, and another end of the first air nozzle extends out of the first airbag to an external environment,
the second air orifice is at a side wall of one second airbag of the at least two second airbags on the first cushion layer. one end of the second air nozzle is in the second air orifice, and another end of the second air nozzle extends out of the second airbag to the external environment.

14. The air inflatable massage cushion according to claim 1, wherein each body of the at least one body comprises two first cushion layers at two opposite surfaces of a corresponding body of the at least one body, respectively, the second cushion layer is between the two first cushion layers, each of the two first cushion layers protrudes away from the second cushion layer to form the first inflating structure and the second inflating structure, respectively.

15. The air inflatable massage cushion according to claim 2, wherein each of at least part of the first air passage and at least part of the second air passage is a linear air channel.

16. The air inflatable massage cushion according to claim 2, wherein the first air passage comprises a plurality of first sub-airbags and a plurality of first sub-air channels, each of the plurality of first sub-air channels is correspondingly connected to two adjacent first sub-airbags of the plurality of first sub-airbags, and the second air passage comprises a plurality of second sub-airbags and a plurality of second sub-air channels, each of the plurality of second sub-air channels is correspondingly connected to two adjacent second sub-airbags of the plurality of second sub-airbags, wherein the plurality of first sub-airbags is interconnected, and the plurality of second sub-airbags is interconnected.

17. The air inflatable massage cushion according to claim 2, wherein the at least two first airbags, the at least two second airbags, the first air passage and the second air passage are integrated structure.

18. An air inflatable massage cushion, connectable with a control box, the air inflatable massage cushion comprising:
at least one body comprising an inflation portion and an edge portion arranged surrounding the inflation portion,
wherein the inflation portion comprises a first air channel extending along one side of the edge portion and a second air channel extending along another side of the edge portion, a first air inflation unit in air communication with the first air channel and comprising at least two first airbags, and a second air inflation unit in air communication with the second air channel and comprising at least two second airbags, the at least two first airbags are connected each other via a first group of first air guide channels, the at least two second airbags are connected each other via a second group of second air guide channels, the at least two interconnected first airbag are airtight sealed from the at least two second airbags,
each body of the at least one body further comprises:
a first cushion layer and a second cushion layer stacked with the first cushion layer, each of the first air channel, the second air channel, the at least two first airbags, and the at least two second airbags is a hollow structure of protrusion of the first cushion layer protruding away from the second cushion layer,
a first air orifice positioned corresponding to the first air inflation unit in one of the first cushion layer and the second cushion layer, and configured to be in air communication with a first airbag of the at least two first airbags;
a second air orifice positioned corresponding to the second air inflation unit in one of the first cushion layer and the second cushion layer, and configured to be in air communication with a second airbag of the at least two airbags;
a first air nozzle arranged at the first air orifice and a second air nozzle arranged at the second air orifice,
the first air inflation unit is connected to the control box via the first air channel, and the second air inflation unit in the inflation portion is connected to the control box via the second air channel, and in response to one of the first air inflation unit and the second air inflation unit is inflating, another one of the first air inflation unit and the second air inflation unit is deflating, the inflation portion dynamically changes height in a staggered manner.

19. An air inflatable massage cushion, connectable with a control box, the air inflatable massage cushion comprising:
at least one body comprising an inflation portion and an edge portion arranged surrounding the inflation portion,
wherein the inflation portion comprises a first air passage extending along one side of the edge portion, a second air passage extending along another side of the edge portion, a first air inflation unit in air communication with the first air passage and comprising a plurality of first airbag groups arranged in parallel, a second air inflation unit in air communication with the second air passage and comprising a plurality of second airbag groups arranged in parallel,
each of the plurality of first airbag groups comprises at least one first airbag connected in series,
each of the plurality of second airbag groups comprises at least one second airbag connected in series,
the first air passage comprises a plurality of first sub-airbags and a plurality of first sub-air channels, each of the plurality of first sub-air channels is correspondingly connected to two adjacent first sub-airbags of the plurality of first sub-airbags, and the second air passage comprises a plurality of second sub-airbags and a plurality of second sub-air channels, each of the plurality of second sub-air channels is correspondingly connected to two adjacent second sub-airbags of the plurality of second sub-airbags, wherein the plurality of first sub-airbags is interconnected, and the plurality of second sub-airbags is interconnected,
each body of the at least one body further comprises:
a first cushion layer and a second cushion layer stacked with the first cushion layer, each of the first air channel, the second air channel, the at least two first airbags, and the at least two second airbags is a hollow structure of protrusion of the first cushion layer protruding away from the second cushion layer,
a first air orifice positioned corresponding to the first air inflation unit in one of the first cushion layer and the second cushion layer, and configured to be in air communication with a first airbag of the at least two first airbags;
a second air orifice positioned corresponding to the second air inflation unit in one of the first cushion layer and the second cushion layer, and configured to be in air communication with a second airbag of the at least two airbags;
a first air nozzle arranged at the first air orifice and a second air nozzle arranged at the second air orifice.
in response to one of the first air inflation unit and the second air inflation unit is inflating, another one of the first air inflation unit and the second air inflation unit is deflating, the inflation portion dynamically changes height in a staggered manner.
